(19) United States
(12) Patent Application Publication
(10) Pub. No.: US 2003/0099303 A1
(43) Pub. Date: May 29, 2003

(54) Digital television (DTV) transmission system using enhanced coding schemes

(75) Inventors: Dagnachew Birru, Yorktown Heights, NY (US); Vasanth R. Gaddam, Ossining, NY (US)

Correspondence Address: Corporate Patent Counsel, U.S Philips Corporation, 580 White Plains Road, Tarrytown, NY, 10591, US

(73) Assignee: KONINKLIJKE PHILIPS ELECTRONICS N.V.

(21) Appl. No.: 10/142,585

(22) Filed: May 9, 2002

Related U.S. Application Data
(60) Provisional application No. 60/301,559, filed on Jun. 28, 2001.
(60) Provisional application No. 60/295,616, filed on Jun. 4, 2001.

(51) Int. Cl. H04L 5/12

(52) U.S. Cl. 375/265; 714/792; 714/786; 348/729

(57) ABSTRACT

A digital signal transmission system transmits MPEG data packets including normal packets for transmission as a normal bit stream and robust packets comprising information for transmission as a robust bit stream for receipt by a receiver device. A first encoding device is provided for encoding packets belonging to each robust and normal bit streams. A control device tracks individual bytes belonging to the robust and normal bit streams. A formatter device formats tracked bytes of packets belonging to the robust bit stream and, a trellis encoder device produces a stream of trellis encoded bits corresponding to bits of the normal and robust streams. The trellis encoder additionally maps the trellis encoded bits of both robust and normal bytes into symbols. A second encoding device responsive to the control device applies a non-systematic Reed Solomon encoding to formatted packets belonging to the robust bit stream when a backward compatibility mode is indicated. A transmitter device transmits the enhanced encoded robust bit stream, separately or in conjunction with the normal bit stream over a fixed bandwidth communication channel to the receiver device.

### CROSS-REFERENCE TO RELATED APPLICATION

The present invention claims the benefit of commonly-owned, co-pending U.S. Provisional Patent Application Serial No. 60/301,559filed Jun. 28, 2001. This patent application is additionally related to commonly-owned, co-pending U.S. Provisional Patent Application Serial No. 60/280,782 filed Apr. 2, 2001 entitled ENHANCED ATSC DIGITAL TELEVISION SYSTEM, and commonly-owned, co-pending U.S. Provisional Patent Application Serial No. 60/295,616filed Jun. 4, 2001, the entire contents and disclosures of each of which are incorporated by reference as if fully set forth herein.

### BACKGROUND OF THE INVENTION

1. Field of the Invention

The present invention relates to digital transmission systems and particularly, to an enhanced digital signal broadcast system and method for transmitting a normal stream and an enhanced (robust) bitstream. All packets corresponding to the normal stream are sent using the existing 8-VSB coding scheme for decoding by legacy receivers as well as the new receivers. All packets corresponding to the robust stream are sent using an enhanced coding scheme in a backward compatible manner.

2. Discussion of the Prior Art

The ATSC standard for high-definition television (HDTV) transmission over terrestrial broadcast channels uses a signal that comprises a sequence of twelve (12) independent time-multiplexed trellis-coded data streams modulated as an eight (8) level vestigial sideband (VSB) symbol stream with a rate of 10.76 MHz. This signal is converted to a six (6) MHz frequency band that corresponds to a standard VHF or UHF terrestrial television channel, over which the signal is broadcast at a data rate of 19.39 million bits per second (Mbps). Details regarding the (ATSC) Digital Television Standard and the latest revision A/53 is available at http://www.atsc.org/.

FIG. 1 is a block diagram generally illustrating an exemplary prior art high definition television (HDTV) transmitter 100. MPEG compatible data packets are first randomized in a data randomizer 105 and each packet is encoded for forward error correction (FEC) by a Reed Solomon (RS) encoder unit 110. The data packets in successive segments of each data field are then interleaved by data interleaver 120, and the interleaved data packets are then further interleaved and encoded by trellis encoder unit 130. Trellis encoder unit 130 produces a stream of data symbols having three (3) bits each. One of the three bits is pre-coded and the other two bits are produced by a four (4) state trellis encoder. The three (3) bits are then mapped to an 8-level symbol.

As known, a prior art trellis encoder unit 130 comprises twelve (12) parallel trellis encoder and pre-coder units to provide twelve interleaved coded data sequences. In multiplexer 140 the symbols of each trellis encoder unit are combined with “segment sync” and “field sync” synchronization bit sequences 150 from a synchronization unit (not shown). A small in-phase pilot signal is then inserted by pilot insertion unit 160 and optionally pre-equalized by filter device 165. The symbol stream is then subjected to vestigial sideband (VSB) suppressed carrier modulation by VSB modulator 170. The symbol stream is then finally up-converted to a radio frequency by radio frequency (RF) converter 180.

FIG. 2 is a block diagram illustrating an exemplary prior art high definition television (HDTV) receiver 200. The received RF signal is down-converted to an intermediate frequency (IF) by tuner 210. The signal is then filtered and converted to digital form by IF filter and detector 220. The detected signal is then in the form of a stream of data symbols that each signify a level in an eight (8) level constellation. The signal is then provided to NTSC rejection filter 230 and to synchronization unit 240. Then the signal is filtered in NTSC rejection filter 230 and subjected to equalization and phase tracking by equalizer and phase tracker 250. The recovered encoded data symbols are then subjected to trellis decoding by trellis decoder unit 260. The decoded data symbols are then further de-interleaved by data de-interleaver 270. The data symbols are then subjected to Reed Solomon decoding by Reed Solomon decoder 280. This recovers the MPEG compatible data packets transmitted by transmitter 100.

While the existing ATSC 8-VSB A/53 digital television standard is sufficiently capable of transmitting signals that overcome numerous channel impairments such as ghosts, noise bursts, signal fades and interferences in a terrestrial setting, there exists a need for flexibility,in the ATSC standard so that streams of varying priority and data rates may be accommodated.

### SUMMARY OF THE INVENTION

Accordingly, it is an object of the present invention to provide a flexible ATSC digital transmission system and methodology that permits transmission of a more robust bit stream encoded using an enhanced coding scheme.

It is a further object of the present invention to provide in an ATSC digital transmission system, an enhanced technique for transmitting a new bit-stream along with the standard ATSC bit-stream wherein the new bit-stream has a lower Threshold of Visibility (TOV) compared to the ATSC stream, and consequently can be used for transmitting high priority information bits (robust bit-stream).

It is yet another object of the present invention to incorporate within the existing ATSC digital transmission standard an enhanced technique for transmitting a new bit-stream along with the standard ATSC bit-stream wherein the new bit-stream includes high priority information bits, and such that the transmission is backward compatible with existing digital television receiver devices.

It is another object of the present invention to provide a flexible ATSC digital transmission system and methodology that provides a parity-byte generator mechanism for enabling backwards compatibility with the existing receiver devices.

In accordance with the preferred embodiments of the invention, there is provided a digital transmission system and method that improves upon the existing ATSC A/53 HDTV signal transmission standard by transmitting not only encoded data packets including normal packets for transmission as a normal bit stream but, in addition, transmits robust packets comprising information for transmission as a robust bit stream for receipt by a receiver device. The system comprises:

a first encoding device for encoding packets belonging to each said robust and normal bit streams;

a control means for tracking individual bytes belonging to said robust and normal bit streams and indicating an encoding mode;

formatting means for formatting tracked bytes belonging to robust packets of said robust bit stream;

a trellis encoder means for producing a stream of trellis encoded bits corresponding to bits of said normal and robust streams, said trellis encoder employing means for mapping trellis encoded bits of said robust and normal packets into symbols;

a second encoding device responsive to said control means for applying non-systematic Reed-Solomon (RS) encoding to formatted packets belonging to said robust bit stream when a backward compatibility mode is indicated; and,

a transmitter device for transmitting said robust bit stream, separately or in conjunction with said normal bit stream over a fixed bandwidth communication channel to said receiver device.

To insure backward compatibility with existing receivers from various manufacturers, a non-systematic Reed-Solomon encoder is used to add parity bytes to the robust bit-stream packets. The standard 8-VSB bit-stream will be encoded using the ATSC FEC scheme (A/53). Packets transmitted using the new bit-stream will be ignored by the transport layer decoder of the existing receiver. Thus, the effective payload that can be decodable by existing receivers is reduced due to the insertion of the new bit-stream.

Advantageously, the changes needed to support the new DTV transmitter occur mainly in the modem part of the system with little change assumed on the transport layer.

### BRIEF DESCRIPTION OF THE DRAWINGS

Details of the invention disclosed herein shall be described below, with the aid of the figures listed below, in which:

FIG. 1 illustrates a block diagram of an exemplary high definition television (HDTV) transmitter according to the prior art;

FIG. 2 illustrates a block diagram of an exemplary high definition television (HDTV) receiver according to the prior art;

FIG. 3 is a top-level diagram of a preferred embodiment 300 of the enhanced ATSC digital transmission system according to the present invention.

FIG. 4(a) is a detailed block diagram of the robust packet interleaver/formatter processing element 115 for processing only packets belonging to a robust bitstream;

FIG. 4(b) is a byte shift register illustration of the interleaver device 401 employed in the robust processor block 115;

FIG. 5 is a block diagram illustrating a trellis encoding scheme 330 implemented in the transmission systems of FIG. 3;

FIG. 6 is a simplified block diagram illustrating the upper coding circuit 335 of the modified trellis encoder 330 according to the invention;

FIG. 7 illustrates in detail the Non-systematic Reed Solomon encoder and parity byte generator block 125 according to the invention;

FIGS. 8(a) and 8(b) illustrate the basic formatter function of duplicating the bytes of a packet into two bytes when MODE=2 or 3, and respectively for the case when NRS=0 (FIG. 8(a)) and NRS=1 (FIG. 8(b));

FIGS. 9(a) and 9(b) illustrate the basic formatter function of rearranging the bits of an input packet into two bytes when the MODE=1, and respectively for the case when NRS=0 (FIG. 9(a)) and NRS=1 (FIG. 9(b));

FIG. 10 illustrates the parity ‘place-holder’ insertion mechanism for an example scenario; and,

FIG. 11 illustrates a top-level diagram of the control unit 214.

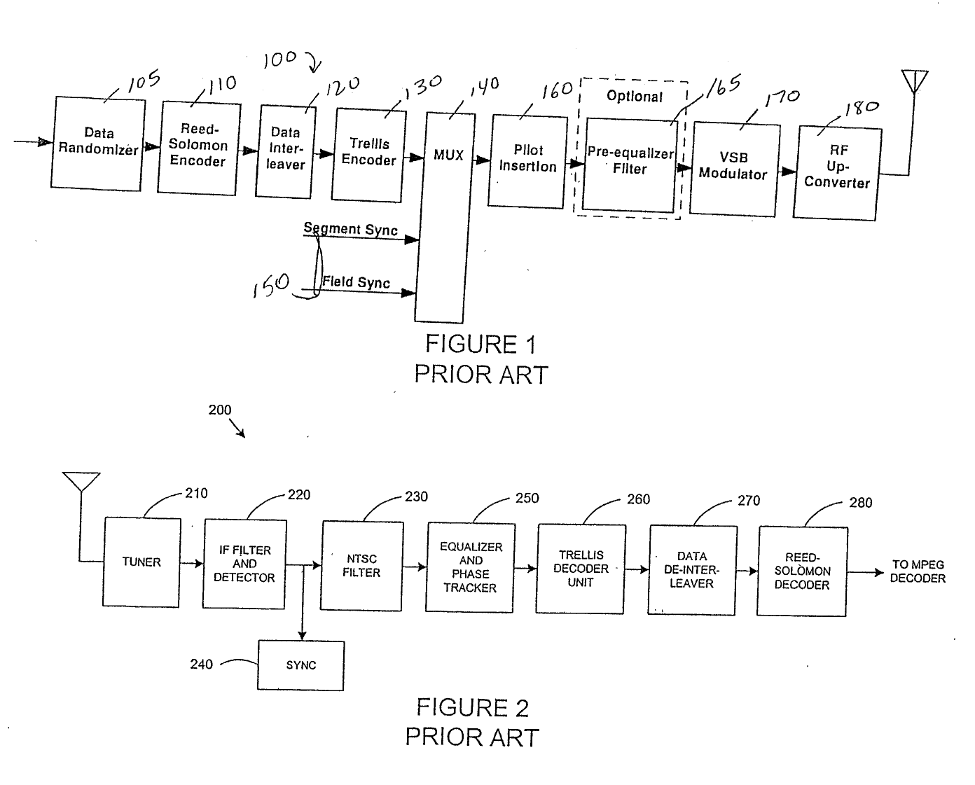

### DETAILED DESCRIPTION OF THE PREFERRED EMBODIMENTS

A new approach for the ATSC digital transmission system standard comprising the means and methodology for transmitting a new “robust” bit-stream along with the standard ATSC (8-bit) bit-stream, wherein the new bit-stream has a lower Threshold of Visibility (TOV) compared to the standard 8-VSB ATSC stream, and consequently can be used for transmitting high priority information bits, is described in co-assigned, co-pending U.S. patent application Ser. No. ______ [US010173, Attorney Docket No. 15062] entitled ENHANCED ATSC DIGITAL TELEVISION SYSTEM, the whole contents and disclosure of which is incorporated by reference as if fully set forth herein.

Most notably, the new features provided with the proposed ATSC digital transmission system and methodology described in herein incorporated co-pending U.S. patent application Ser. No. [US010173, Attorney Docket No. 15062], include the mechanism for enabling a trade-off of the standard bit-stream's data rate for the new bit-stream's robustness which will enable new receiver devices to decode robust packets without errors even under severe static and dynamic multi-path interference environments at a reduced CNR and reduced TOV, and further, a mechanism that enables backward compatible transmission with existing digital receiver devices. The system described particularly improves upon the current ATSC digital transmission system standard by enabling flexible transmission rates for Robust and Standard streams for accommodating a large range of carrier-to-noise ratios and channel conditions.

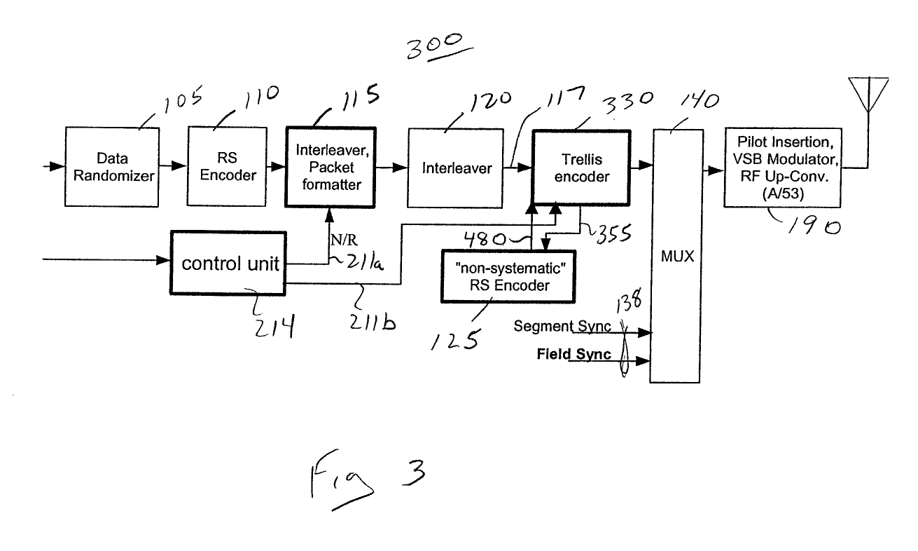

FIG. 3 is a top-level diagram of a preferred embodiment 300 of the enhanced ATSC standard according to the present invention. As shown in FIG. 3, the enhanced ATSC digital signal transmission standard according to a preferred embodiment includes the data randomizer element 105 for first changing the input data byte value according to a known-pattern of pseudo-random number generation. According to the ATSC standard, for example, the data randomizer XORs all the incoming data bytes with a 16-bit maximum length pseudo random binary sequence (PRBS) that is initialized at the beginning of a data field. The output randomized data is then input to the Reed Solomon (RS) encoder element 110 which operates on a data block size of 187 bytes, and adds twenty (20) RS parity bytes for error correction to result in a RS block size total of 207 bytes transmitted per data segment. It is these bytes that will then be post processed and sent using robust constellations. After the RS encoding, the 207 byte data segment is then input to a new block 115 comprising a robust interleaver, packet formatter and packet multiplexer elements for further processing/reformatting the robust input bytes. Details regarding the operation of the individual elements of the packet formatter block will be described in greater detail herein. Most generally, the robust interleaver, packet formatter and packet multiplexor elements 115 for reformatting incoming bytes are responsive to a mode signal 211a which indicates whether the incoming byte is processed (for robust bytes) or not (for normal bytes). This is to ensure that only robust packets are interleaved by the robust packet interleaver/formatter device 115. This mode signal is generated by a control unit 214 which generates the needed bits to control the multiplexing of packets and the encoding scheme.

Although not shown in FIG. 3, after byte re-formatting in the packet formatter 115, the bytes belonging to robust packets are multiplexed with the bytes belonging to the standard stream. The multiplexed stream of robust and standard bytes are next input to the convolutional interleaver mechanism 120 where data packets in successive segments of each data field are further interleaved for scrambling the sequential order of the data stream according to the ATSC A/53 standard. As mentioned, bytes associated with each robust packet or standard packet are tracked in concurrent processing control block 214. As further shown in FIG. 3, the interleaved, RS-encoded and formatted data bytes 117 are then trellis coded by a novel trellis encoder device 330. Trellis encoder unit 330 is particularly responsive to the mode signal 211b and cooperatively interacts with a backwards compatibility parity-byte generator element, herein referred to as a backward compatibility (or optional or “non-systematic” RS encoder) block 125 in the manner as will be explained in greater detail herein, to produce an output trellis encoded output stream of data symbols having three (3) bits each mapped to an 8-level symbol. The trellis encoded output symbols are then transmitted to multiplexor unit 140 where they are combined with the “segment sync” and “field sync” synchronization bit sequences 138 from a synchronization unit (not shown). Operations for inserting a pilot signal, subjecting the symbol stream to vestigial sideband (VSB) suppressed carrier modulation by VSB modulator and, finally up-converting to a radio frequency by the radio frequency (RF) converter is performed as indicated by generic block 190.

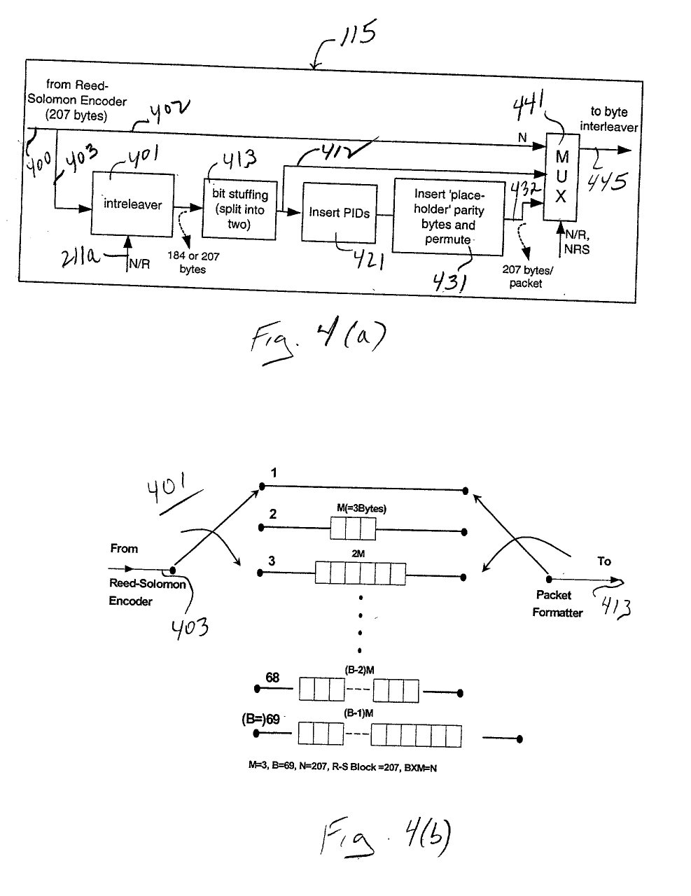

As now described herein with respect to FIG. 4(a), there is depicted a detailed block diagram of the robust packet interleaver/formatter processing element 115 for processing only packets belonging to a robust bitstream. This processing element 115 includes an input for receiving the MPEG data packets 400 to be communicated as a robust stream 403, an interleaver device 401, a packet formatter block comprising a bit stuffing element 413, a packet Identification. (PID) inserter block 421, and, a ‘placeholder’ parity bytes and permute insertion device 431. A normal/robust multiplexor (N/R MUX) device 441 is provided for eventually multiplexing the robust packets out of the processor block with the normal packets of the standard ATSC stream 402 for eventual transmission as an ATSC stream 445 comprising both normal and robust packets. Preferably, the normal stream packets are multiplexed with the robust packets according to a pre-defined algorithm, an exemplary algorithm of which will be described in greater detail herein. As further shown in FIG. 4(a), if the N/R indicator signal 211a is zero (N/R=0), then the mux 441 selects the RS encoded normal stream 402; otherwise, if N/R=1 and input parameter NRS=0 (non-systematic RS encoding not used) then the mux 441 selects robust stream 412. Alternately, if N/R=1 and NRS=1 then the mux 441 selects the output 432 of parity byte placeholder element 431.

In one embodiment, as shown in FIG. 4(b), the interleaver device 401 employed in the robust processor block 115 is a 69 data segment (intersegment) convolutional byte interleaver for interleaving only robust bytes 403 from bit stream 400. The interleaver is synchronized to the first data byte of each robust packet. It is understood that variations of robust interleaver structures may be derived by changing the values of M and B as long as the product of M and B is 207, where M is the length of the memory element and B is the number of segments (i.e., number of rows). In a preferred embodiment illustrated in FIG. 4(b), the value of “M” is 3 bytes and the value of “B” is 69.

In FIG. 4(a), after interleaving robust packets in the robust packet interleaver, the data bytes belonging to the incoming robust bit-stream are post-processed and subject to the bit-stuffing, PID byte insertion, ‘place-holder’ parity byte insertion and byte permutation operations. As will be described in greater detail herein, there are two types of processing that depend on the use of the ‘non-systematic’ RS (NRS) encoder 125 (FIG. 3) for legacy receivers.

In view of FIG. 4(a), in a first processing option when the ‘non-systematic’ RS encoder 125 is used, the bit-stuffing unit 411 reads 184 byte packets from the interleaver and splits each of these bytes into two 184-byte data blocks by inserting bits. In general, only 4 bits of each byte, the LSBs (6,4,2,0), correspond to the incoming stream. The other 4 bits of each byte, the MSBs (7,5,3,1), are initially set to any value. After packet splitting is done, the PID inserter 411 inserts three NULL PID bytes at the beginning of each of the two 184-byte length data. Then 20 ‘place-holder’ parity bytes are added to each data block to create two 207-byte packets. In creating the 207 bytes, the 184 bytes representing the information stream and the 20 ‘place-holder’ parity bytes will be permuted in such a way that after the standard 8-VSB data interleaver 120 (FIG. 3), these 20 bytes will appear at the end of the 184 bytes containing the information bits. The insertion of parity ‘place-holders’ by the packet formatter element of the HDTV digital transmission system of FIG. 3 will be described in greater detail herein. However, at this stage, the values of the 20 bytes can be set to zero. This option, incorporated for the purpose of insuring backward compatibility with legacy receivers, will reduce the effective data rate since 23 bytes (i.e., 20 parity bytes and 3 header bytes) have to be added per packet.

In a second option, when the ‘non-systematic’ RS encoder is not used, the bit-stuffing unit 411 reads a packet of 207 bytes from the interleaver and splits these bytes into two 207-byte packets by inserting bits. In general, only 4 bits of each byte, the LSBs (6,4,2,0), correspond to the incoming stream. The other 4 bits of each byte, the MSBs (7,5,3,1), can be set to any value. Further processing (PID and parity byte insertion) is bypassed as represented by the line 412 in FIG. 4(a). In both first and second options, it is understood that the Robust/Normal packet MUX 405 is a packet (207 byte) level multiplexer. It multiplexes the processed robust packets and normal packets on a packet-by-packet basis.

For purposes of discussion, and, as explained in greater detail in commonly-owned, co-pending U.S. patent application Ser. No. ______ [Attorney Docket No. US010278, D#15061], the contents and disclosure of which is incorporated by reference as if fully set forth herein, the control mechanism 214 is provided for tracking the type of packets transmitted, i.e., normal or robust. Thus, as shown in FIG. 4(a), associated with each byte there is generated a normal/robust (“N/R”) signals 211a and 211b each of which comprises a bit used to track the progression of the bytes and identify the bytes at different stages of the enhanced ATSC digital signal transmission scheme of the invention.

Generally, for the embodiment of the enhanced ATSC system described herein, transmission of robust packets requires knowledge of the manner by which the robust packets are multiplexed with the normal packets at the MPEG multiplexor element 441 included with the robust packet interleaver/processor block 115. The packets need to be inserted in such a manner that they improve the dynamic and static multipath performance of a receiver device. One exemplary algorithm governing the multiplexing of robust stream packets with the normal stream packets in the robust processor block 115 of FIG. 3, is now described with respect to the Table 1. The packet insertion algorithm is enabled to exploit the robust packets to enable better and robust receiver design.

At the beginning of an MPEG field, a group of robust packets is placed contiguously, then the rest of the packets are inserted using a predetermined algorithm, as now described with respect to Table 1. The first group of packets will help the equalizer in faster acquisition in both static and dynamic channels. This robust packet insertion algorithm is implemented before interleaving for every field. With respect to the example robust packet insertion algorithm of Table 1, the following quantities and terms are first defined: a first quantity referred to as “NRP” represents the number of robust segments occupied by robust packets per field (i.e., indicates the Number of Robust Packets in a frame); the quantity referred to as “M” is the number of contiguous packet positions occupied by robust bit-stream immediately following the field sync; the character “U” represents the union of two sets; and, “floor” represents the truncation of a decimal so that values are rounded to an integer value. As shown in Table 1, the algorithm comprises performing the following evaluations to determine the placement of the robust packet in the bit stream:

TABLE 1
If 0<NRP≦M, then

robust packet position = {0, 1, ..., NRP−1}

If M < NRP ≦ floor((312-M)/4)+M, then

robust packet position = {0, 1, ..., M−1} U

{M+4i, i = 0, 1, ..., (NRP − M−1) }

If floor((312-M)/4)+M < NRP≦ floor((312-M−
2)/4)+floor((312-M)/4)+M, then

robust packet number = {0, 1, ..., M−1} U {M+4i,

i = 0, 1, ..., floor((312-M)/4) −
1} U {M+2+4i, i = 0, 1, ..., NRP −
(floor((312-M)/4)+M) - 1}

If floor((312-M−2)/4)+floor((312-M)/4)+M < NRP ≦
312, then

robust packet number = { 0, 1, ..., M−1} U

{M+4i, i = 0, 1, ..., floor((312-
M)/4) −1} U {M+2+4i, i = 0, 1,
..., floor((312-M−2)/4)−1} U
{M+1+2i, i = 0, 1, ..., NRP − (M+
floor((312-M)/4) + floor((312-M−
2)/4)) −1}

Thus, in an example implementation for the case when M=18, the above algorithm results in the following algorithm for robust packet placement:

If 0<NRP≦18, then robust packet position={0, 1, . . . , NRP−1}

If 18<NRP≦91, then robust packet position={0, 1, . . . , 17}U{18+4i, i=0, 1, . . . , (NRP−19)}

$$If 91 < NRP \leq 164 , then$$

$$\begin{matrix}robust packet position = \{ 0 , 1 , … , 17 \} U \\ \{ 18 + 4 i , i = 0 , 1 , … , 72 \} U \\ \{ 20 + 4 i , i = 0 , 1 , … , NRP - 92 \}\end{matrix}$$

$$If 164 < NRP \leq 312 , then$$

$$\begin{matrix}robust packet position = \{ 0 , 1 , … , 17 \} U \\ \{ 18 + 4 i , i = 0 , 1 , … , 72 \} U \\ \{ 20 + 4 i , i = 0 , 1 , … , 72 \} U \\ \{ 19 + 2 i , i = 0 , 1 , … , NRP - 165 \}\end{matrix}$$

Returning to FIG. 3, the top-level operation of the modified trellis encoder 330 according to the principles of the invention, is governed by the rule described in section 4.2.5 of the ATSC A/53 transmission standard. This top-level operation is related to trellis interleaving, symbol mapping, the manner in which bytes are read into each trellis encoder, etc. Trellis encoding of the normal 8-VSB packets is not altered. However, the trellis encoder block according to the ATSC A/53 standard is modified in order to perform functions of: 1) by-passing a pre-coder device if the bytes belong to the robust bit-stream; 2) deriving each MSB bit if the byte belongs to the robust stream and then sending the new byte to a ‘byte de-interleaver’ block in the non-systematic RS encoder; 3) reading the parity bytes from ‘byte de-interleaver’ block and using them (if they belong to robust stream) for encoding; and 4) utilizing modified mapping schemes to map symbols belonging to the robust bit-stream. It should be understood that, preferably, parity bytes are mapped onto eight (8) levels.

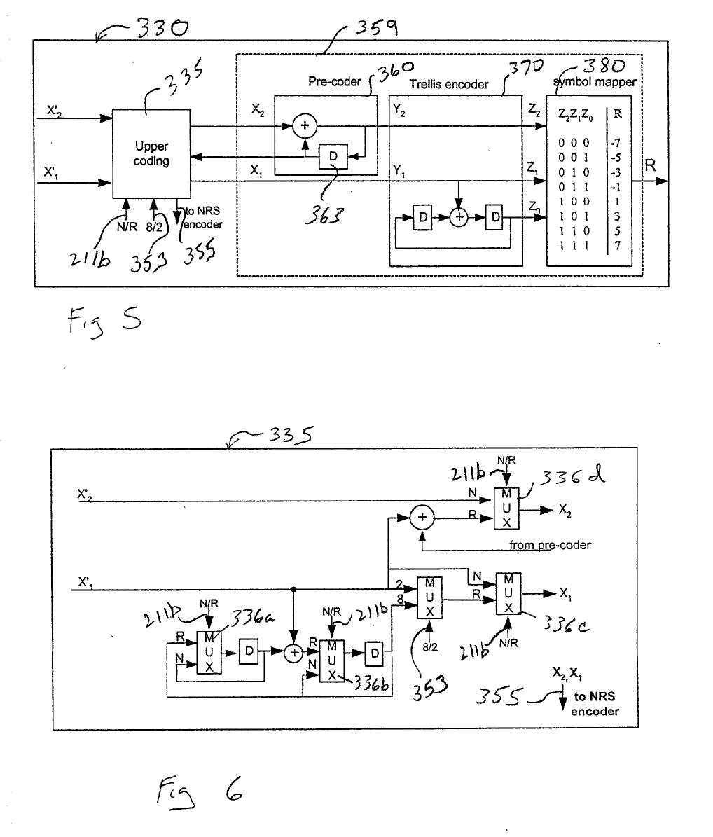

With regard to the functions of bypassing the pre-coder and forming the byte, this process is mode dependent as will now be described with respect to modified trellis encoder diagrams of FIGS. 5 and 6. FIG. 6 particularly discloses the upper coding scheme in the trellis encoder configured to obtain a 16-state trellis encoder for the robust stream.

Particularly, FIG. 5 is a block diagram illustrating a trellis encoding scheme 330 implemented in the HDTV digital signal transmission system of FIG. 3. For enhanced 8-VSB (E-VSB), or 2-VSB streams, each trellis encoder receives a byte, of which only 4-bits (LSBs) comprise information bits. When a byte that belongs to the robust stream is received by the trellis encoder, the information bits (LSBs, bits (6,4,2,0)), (after encoding for E-VSB mode) are placed on X₁. The bit to be placed on X₂ to obtain the particular symbol mapping scheme is then determined. Once X₂ and X₁ are determined, all the bits of a byte are then determined for the purpose of subsequent “non-systematic” RS encoding. This byte is then passed to the backwards compatibility “non-systematic” Reed-Solomon encoder 125 via datalines 355. The parity bytes of the “non-systematic” Reed-Solomon encoder and PID bytes will however be encoded using the 8-VSB encoding scheme. The operation in the upper trellis encoding block 335 of the trellis encoder 330 for each of the digital signal modulation modes is now described with respect to FIG. 6.

The upper trellis encoding block 335 shown in FIG. 6 calculates the pre-coder 360 and trellis encoder 370 inputs, X₂ and X₁, respectively, of the standard trellis encoder block 359, so that the desired symbol mapping or encoding scheme is achieved. For example, these encoding schemes are for the standard 8-VSB, (enhanced) E-VSB and 2-VSB and a “8/2” control bit 353 is input for indicating the correct encoding (symbol mapping scheme). The output bits of this block are grouped into their respective bytes, and eventually fed into the “non-systematic” RS encoder block for parity byte generation. The Normal/Robust control bits 211b needed to configure the multiplexers 336a, . . . , 336d in FIG. 6 are provided by the tracking/control mechanism block 214 in FIG. 3.

Thus, for the Normal (standard) 8-VSB symbol mapping mode, the input bits X′₂ and X′₁ received from the previous interleaver block 120 and input to the upper coder 335 of trellis encoder 330 are passed unaltered to the normal trellis encoder comprising pre-coder 360 and encoder 370 units. This is achieved by making the N/R control bit 211b select the N input of the multiplexers. The 8/2 bit 353 is set to further control the trellis mapping scheme to be employed when N/R bit is ‘R’ (robust).

For the 2-VSB mode symbol mapping mode, the MSB does not carry any information. To satisfy mapping requirements, the Z₂ bit is calculated first and then modulo-2 summed with pre-coder memory content 363 (FIG. 5) to derive the MSB X₂. A new byte is formed from the calculated MSB and the input information bit X₁. The memory element is then updated with Z₂. Thus, for the 2-VSB mode, the trellis encoder outputs Z₂ and Z₁ are made equal to the information bit. That is, input X₂ is calculated such that, when pre-coded, the output of the pre-coder Z₂ equals the information bit. This operation is implemented in the upper coding circuit 335 illustrated in FIG. 6. In addition, X₁ is made equal to the information bit. These operations, combined with the existing symbol mapping scheme enabled by trellis encode symbol mapper 380, result in symbols from the alphabet {−7,−5,5,7}. This is essentially a 2-VSB signal in the sense that the information bit is transmitted as the sign of this symbol. The actual symbol is a valid trellis coded 4-level symbol capable of being decoded by existing trellis decoders. For example, to achieve 2-VSB encoding, N/R bit 211b is set to select the R input and the 8/2 switch 353 is set to select the ‘2’ input of the multiplexers 336a, . . . , 336d.

For the Enhanced 8-VSB mode (E-VSB) mode, X₂ and X₁ correspond to the outputs of the enhanced coder (i.e., upper coder 335). These bits have to be used in forming the bytes instead of the actual inputs. Accordingly, in this mode, Z₂ is made equal to the information bit by putting a trellis-coded version of the information bit on X₁. In order to do this, X₂ is calculated such that, when pre-coded, it results in the information bit. The information bit is also passed through an additional trellis encoder to produce X₁. Overall, for E 8-VSB, the outer coder 335 and the normal trellis encoder 359 will be equivalent to a higher state (e.g., 16-state) ⅓ rate trellis encoder. The resulting symbol is an 8-level trellis coded symbol. To achieve Enhanced 8-VSB encoding, the N/R bit 211b is set to select the R input and the 8/2 switch 353 is set to select the “8” input of the multiplexers 336a, . . . , 336d.

In each of these modes, a symbol to byte converter introduces a delay of 12 bytes.

As mentioned, there exist two options as to how the new packets will be processed by existing receivers. The first option is one for which the new packets are not correctly decoded by the Reed-Solomon decoders of existing receivers. The second option is one for which the new packets will be decoded correctly by the Reed-Solomon decoders of existing receivers. Existing receivers will not however be able to decode (display) the information from these packets. This option is proposed to provide the flexibility to cover the widest possible set (perhaps all) of the existing receivers from different manufacturers. The use of the additional non-systematic (NRS) encoder 125 to ensure backward compatibility, however, reduces the total payload by 23 bytes per packet.

It should be understood that the Reed-Solomon encoder defined in the existing ATSC standard appends parity bytes at the end of the 187-byte packet to yield a 207-byte codeword. This encoding scheme is commonly referred to as a systematic code. However, the parity bytes need not be appended to the message word. Given a particular application, the encoding may be performed in such a way that the parity bytes are placed in arbitrary positions in the total 207 available byte positions. The resulting codeword is a valid Reed-Solomon codeword from the systematic code family. A Reed-Solomon decoder does not need knowledge of the parity byte positions. Thus, an unmodified Reed-Solomon decoder that decodes the systematic code will also decode this code.

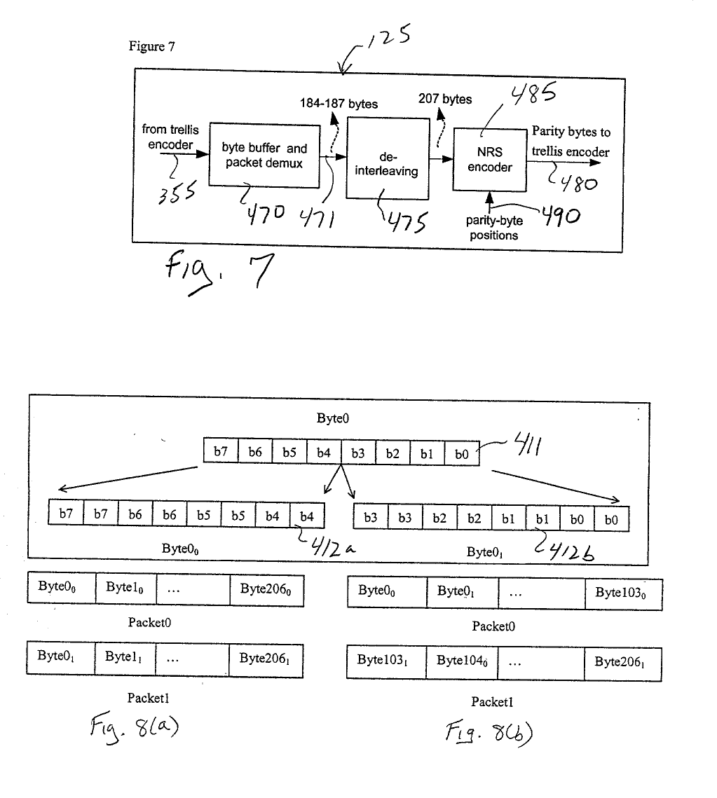

FIG. 7 illustrates in detail the non-systematic RS encoder and parity byte generator block 125 according to the invention. In the encoding process, the “non-systematic” Reed-Solomon encoder collects all the 184 message bytes corresponding to the robust stream and the PID bytes appearing in between these message bytes as produced by the trellis encoder 330. Given the positions 490 of the parity bytes, the Reed-Solomon encoder then produces 20 parity bytes 480 corresponding to this packet. The parity bytes 480 will then be appropriately placed in the data interleaver at the positions corresponding to the parity byte positions of the 207-byte packet. As shown in FIG. 7, this non-systematic RS and parity byte generator block 125 comprises a trellis de-interleaver block 470 for receiving the X₁ and X₂ bits from the trellis encoder block 330, a parity byte generator/inserter and de-interleaver block 475, and a “non-systematic” RS encoder 485 for reading in a packet from the byte de-interleaver block and then RS encoding it to generate the parity bytes. Particularly, the byte de-interleaver and parity byte generator blocks 475, 485 perform the functions of: accumulating the message bytes belonging to a packet; and RS encoding the message bytes to generate the 20 parity bytes. The input to the byte de-interleaver block is the interleaved bytes 471 generated from the trellis encoded symbols. These bytes have to be de-interleaved so that the ‘non-systematic’ RS encoder may generate parity bytes corresponding to each packet of message bytes. It generates the parity bytes only for robust stream packets used for backward compatibility, and these parity bytes are input to the convolutional byte interleaver 120 (FIG. 3). An exemplary algorithm used to perform byte buffering, byte de-muxing and de-interleaving is now provided with respect to Table 2:

TABLE 2

| | |
|---|---|
| 1. | Define an array ‘data_bytes’ of size 52 × 207, |
| 2. | Initialize the variables ‘byte_no’, ‘row_no’, |
| | ‘col_no’, ‘row_add’ to zero, |
| 3. | If byte_no = 207*52 then set the ‘read_flag’ and |
| | ‘start_flag’ to 1, |
| 4. | If start_flag = 1 then set read_flag = 1 every 208 |
| | bytes (see packet_formatter block description for |
| | exceptions to this rule), |
| 5. | If start_flag = 1 then read out a packet in order |
| | whenever read_flag is set beginning with packet 0 |
| | (row_no = 0), |
| 6. | Place the message byte (output of trellis encoder) in |
| | data_bytes [row_no] [col_no] |
| 7. | Increment byte_no if ‘byte_stb’ (signal from the |
| | trellis encoder) = 1, |
| 8. | Update ‘row_no’ and ‘col_no’ variables using the |
| | following conditional logic |
| | a) If byte_no = 207*52 then |

byte_no = 0;
row_add = 0;
col_no = 0;
row_no = 0;

b) Else if (byte_no mod 208) = 0 then

row_add = (row_add+1) mod 52;
col_no = row_add;
row_no = row_add;

c) For all other cases

col_no = (col_no+52) mod 207;
row_no = (row_no−1) mod 52; (if row_no−1 < 0

then add 52 to the result)

| | |
|---|---|
| 9. | Go to step 3 |

For some packets (e.g., 1 to 7 mod 52), it will be necessary to have prior information about the randomized header bytes, since not all the header bytes for these packets will be available at the time of RS encoding. That is, for this set of packets, it is the case that some of the header bytes follow the parity bytes at the convolutional interleaver 120 output. Therefore, instead of waiting for these header bytes to calculate the 20 parity bytes, prior information about the header bytes is used (they are deterministic) which are then used instead to calculate the parity bytes.

As explained in the book “Error Control Techniques for Digital Communication”, 1984, John Wiley, NY. by Arnold Michelson & Allen Levesque, an (N, K) RS decoder can correct up to (N-−K)/2 errors or erasure fill up to (N−K) erasures, where “N” is code word length and “K” is message word length. In general, if there are Eₐ erasures and E_{b} errors in a code word of length N, then the decoder can completely recover the code word as long as (Eₐ+2E_{b}) is less than or equal to (N−K) as set forth in equation (1) as follows:

(Eₐ+2×E_{b})≦(N−K) (1)

where Eₐ and E_{b} are the number of erasures and number of errors in the code word respectively.

This property of RS codes may be used to generate the 20 parity bytes. The 20 parity byte locations are then calculated for use as the erasures' location for the RS decoder. The procedure implemented to calculate the parity byte locations is similar to the one used in the packet formatter. The bytes belonging to a packet (with zeroes in parity byte locations) are passed on to the RS decoder as the input code word. The decoder, in the process of erasure filling, calculates the bytes for the erasure locations. These bytes correspond to the 20 parity bytes. The RS Encoder block also generates the parity byte location information. The parity bytes and the header bytes are always encoded as standard 8-VSB symbols.

The parity bytes and their location information for each packet are then sent to the modified trellis encoder device 330 for mapping robust bytes according to new symbol mapping schemes.

With regard to the function of reading parity bytes from the byte de-interleaver, as shown in FIG. 7, this is implemented only when NRS=1 (i.e., non-systematic RS encoding is implemented). The behavior of this functional unit is the same for different modes. The trellis encoder 330 obtains the parity bytes and their location information for each packet from the NRS encoder 125. The trellis encoder 330 may then determine if a particular byte that it is going to encode belongs to the set of parity bytes. If the byte belongs to the robust stream parity byte set, then it reads a byte from the byte de-interleaver and uses it instead to trellis encode. The symbols generated from the parity bytes are always mapped into eight (8) levels using the original encoding and mapping scheme.

As mentioned with respect to FIG. 4(a), the packet formatter's functionality depends on the symbol mapping MODE and NRS parameters. If NRS=0, then the packet formatter basically performs the function of byte duplication or byte rearrangement (block 413). If NRS=1 then it also inserts ‘place holders’ for the additional header and parity bytes (blocks 421 and 431). Table 3 summarizes the packet formatter functionality for different combinations of the MODE and the NRS parameters

TABLE 3

| | | Number of | Number of | |
|---|---|---|---|---|
| | | input | output | |
| NRS | MODE | packets | packets | Functionality |
| 0 | 2,3 | 1 | 2 | Byte duplication |
| 0 | 1 | 2 | 2 | Rearrange bits |
| 1 | 2,3 | 4 | 9 | Byte |
| | | | | duplication, |
| | | | | Insert “place |
| | | | | holders” |
| 1 | 1 | 8 | 9 | Rearrange bits, |
| | | | | Insert “place |
| | | | | holders” |

where the “MODE” parameter includes specification of the robust packets and is used in identifying the format of the robust packets; and, as mentioned, the “NRS” parameter indicates whether the non-systematic RS coder is not to be used (when NRS=0) resulting in one robust packet being coded into two symbol segments by the FEC block, for example, or, whether the non-systematic RS coder is to be used (when NRS=1) resulting, for example, in a group of four robust packets being coded into nine packet segments by the FEC block. With respect to the MODE parameter, two bits are preferably used to identify four possible modes: e.g., MODE 00 indicating a standard stream with no robust packets to be transmitted; MODE 01 indicating an H-VSB stream; MODE 10 indicating an E-VSB stream; and MODE 11 indicating a pseudo 2-VSB stream. If MODE=00 then rest of the parameters may be ignored.

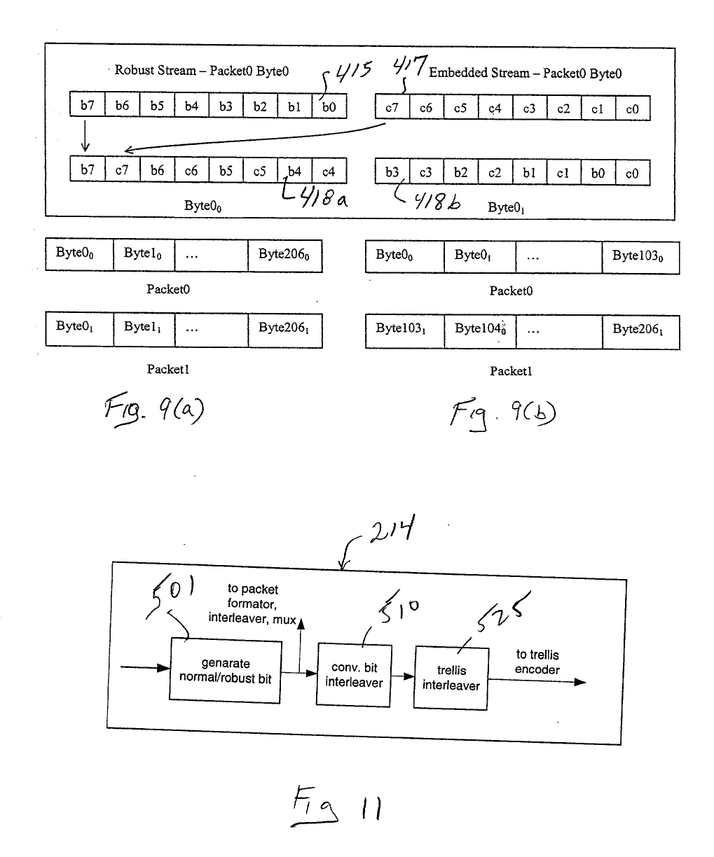

More specifically, in view of FIG. 4(a), the packet formatter blocks 411, 421 and 431 include functional units: that include a parity byte location calculator; and, a ‘place holder’ inserter. As shown in FIGS. 8(a) and 8(b), when the MODE=2 or 3, and respectively for the case when NRS=0 (FIG. 8(a)) and NRS=1 (FIG. 8(b)) MODE=2 or 3, the basic formatter duplicates the bytes of a packet 411 into two bytes 412a, 412b. If the MODE=1 as shown in respective FIGS. 9(a) and 9(b) for the respective cases of NRS=0 (FIG. 9(a)) and NRS=1 (FIG. 9(b)), the basic formatter rearranges the bits of an input packet. The rearranging of bits is performed in the H-VSB mode, for example, to ensure that bits 415 belonging to the ‘robust stream’ always go into MSB bit positions and the bits 417 belonging to the ‘embedded stream’ always go into LSB bit positions of the reformatted packets 418a, 418b, as shown in FIGS. 9(a) and 9(b).

As mentioned, the packet formatter unit 115 of FIG. 4(a) includes a parity ‘place-holder’ inserter function. The parity ‘place-holder’ inserter block is used only when NRS=1 (i.e., when the additional parity byte generator is used). It specifically transforms eight (8) packets into nine (9) packets by inserting three (3) header bytes and twenty (20) ‘place holders’ for parity bytes into each of the eight formed packets. The header bytes are always placed in positions 0, 1 and 2 of each packet, and are scrambled. The byte locations corresponding to the parity byte locations may be first filled with zeroes when formed. All the other remaining byte locations may be filled with the message bytes in order.

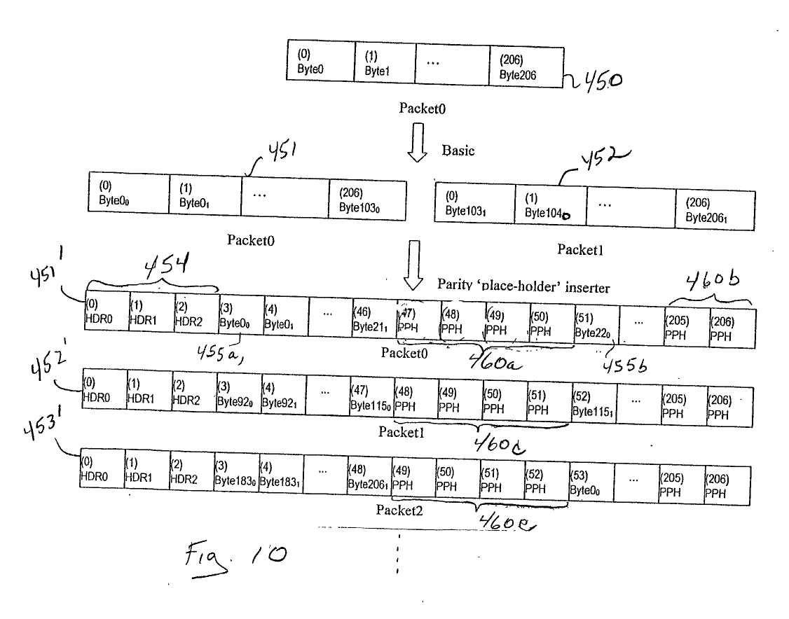

FIG. 10 illustrates the parity ‘place-holder’ insertion mechanism for an example scenario (NRS=1). The basic formatter converts one data packet 450 of 207 bytes into 414 bytes (i.e., equivalent to two (2) packets). The parity byte place holder locations 460a, 460b and 460c for each packet are then determined according to equation 2) as follows:

m=(52*n+(k mod 52)) mod 207 (2)

where m is the output byte number and n is the input byte number, e.g., n=0 to 206, and k=0 to 311 corresponds to the packet number. To ensure that the location of the 20 parity bytes for each packet always correspond to the last 20 bytes of that packet, the ‘m’ values for parity byte locations may be computed for n=187 to 206 only (these values of n correspond to the last 20 bytes of a packet). As an example, substituting k=0 and n=187 to 206 will give parity byte locations for packet 0 as 202, 47, 99, 151, 203, 48, 100, 152, 204, 49, 101, 153, 205, 50, 102, 154, 206, 51, 103, 155. This indicates that the parity byte PB0 should be placed at location 202 in packet 0 so that its position after the interleaver is 187 in packet 0. Similarly, parity byte PB1 has to be placed at location 47 and so on.

It is observed that for some packets, the parity bytes may fall into packet header positions (m=0, 1 or/and 2), i.e., “m” should not equal to 0. 1 or 2, since the first three locations of a packet are reserved for the three null header bytes. To avoid this situation, the range of ‘n’ may be increased by the number of parity bytes falling into header positions (up to 3). Thus, when calculating 20 values of “m” for different packet numbers, it is observed that when “k mod 52”=1-7, some of these “m” values are 0, 1 and/or 2. For instance, when “k mod 52”=0, it is observed that none of the “m” values fall in the header bytes' location. In this case, all the 20 “m” values are designated as the parity palce holder locations. When “k mod 52”=1, it is observed that one of the “m” values is 0 (which is a header byte). In this case, the “n” range is extended by 1 such that “n” becomes 186-206. Thus, 21 “m” values are calculated and those “m” values that fall into header bytes location are discarded. The remaining 20 “m” values are designated as parity place holder locations. When “k mod 52”=2, it may be observed that two of the calculated “m” values happen to be 0 and 1 (which are header bytes). In this case, the “n” range is extended by 2 such that “n” is now 185-206. Thus, 22 “m” values (20+2 additional) are calculated and the “m” values that fall into header byte locations are discarded. The remaining 20 “m” values are designated as parity place holder locations. Table 4 gives the packets numbers for all other exception cases. It also gives the number of additional ‘m’ values to be calculated.

TABLE 4

| Packet | Additional | |
|---|---|---|
| number | ‘m’ values to | |
| mod 52 | be calculated | Range of ‘n’ |
| 0 | 0 | 187-206 |
| 1 | 1 | 186-206 |
| 2 | 2 | 185-206 |
| 3 | 3 | 184-206 |
| 4 | 3 | 184-206 |
| 5 | 3 | 184-206 |
| 6 | 2 | 185-206 |
| 7 | 1 | 186-206 |
| 8-51 | 0 | 187-206 |

More particularly, as shown in FIG. 10, as each packet 450 comprises 207 bytes, the basic formatter will split this into two new packets 451, 452 each comprising 207. The parity placeholder insertion mechanism performed by the packet formatter particularly processes each of the new packets 451,452 to include 20 parity bytes at interleaved locations 460a, 460b, . . . , etc. and 3 header bytes 454. Thus, from new packets 451, 452, the packet formatter will generate new packets 451′, 452′ so as to accommodate all parity and header bits. Thus, new packet 451′ of 207 bytes include 184 bytes of 451, 20 parity place holders and 3 null header bytes 454. As shown in FIG. 10, this implies that one original data packet 450 will be mapped into three new packets 451′, 452′ and a third 453′ with first two completely filled while the third 453′ being only partially filled. Before inserting a data byte into the new packet 451′, 452′,453′, the location is checked to see if it belongs to a parity byte. If the location doesn't correspond to any of the parity bytes' location then the data byte is placed in that location. If the location belongs to a parity byte then that byte location is skipped and the next byte position is checked. The process is repeated until all the bytes are placed in the new packets. As a result of this translation, each of the 9 output packets include 92 bytes from the input packets (e.g., input packet 450). In one embodiment, a minimum granularity of 9 segments is chosen for NRP when NRS=1. When data is read in at the randomizer, 4 packets of a 9-packet block will contain information bytes while the remaining 5 packets will not contain any information. The packet formatter spreads the information in the 4 packets into 9 packets through the process described above. This ensures that the payload data rate will not be given up any more than is necessary.

With the newly proposed technique of the invention, several bits have to be transmitted to a receiver device so that the receiver device may decode the correct mode of transmission. This mode typically includes the number of robust packets, the type of modulation and the level of redundancy inserted for trellis encoding. This information may be transmitted in the reserved bit portion of the field sync segment 138.

Table 5 indicates the parameters that have to be defined in order to correctly identify robust packets at a receiver. As these have to be interpreted at an equalizer device of the receiver, they are heavily protected using robust error correcting codes. The encoded code-word is preferably inserted in the reserved symbol field of a Data Field Sync segment.

TABLE 5

| MODE | NRS | NRP | RPP |
|---|---|---|---|
| (2) | (1) | (4) | (2) |

Table 5 particularly indicates the use of four parameters (and their respective number of bits) to identify robust packets. A first parameter “MODE” includes specification of the robust packets and is used in identifying the format of the robust packets. Two bits are used to identify four possible modes as now described with respect to Table 6:

TABLE 6

| MODE | Description |
|---|---|
| 00 | Standard. No robust |
| | packets in the field |
| 01 | H-VSB mode |
| 10 | E-VSB mode |
| 11 | Pseudo 2-VSB mode |

For instance, as shown in Table 6, the MODE 00 indicates a standard stream with no robust packets to be transmitted; MODE 01 indicates an H-VSB stream; MODE 10 indicates an E-VSB stream; and MODE 11 indicates a pseudo 2-VSB stream is to be transmitted. If MODE=00 then rest of the parameters may be ignored.

Referring back to Table 5, the second “NRS” (Non-systematic Reed-Solomon coder) parameter indicates whether the non-systematic RS encoder is to be used to encode the robust packets. A single bit is used to identify the two possible NRS modes as now described with respect to Table 7:

TABLE 7

| NRS | Description |
|---|---|
| 0 | Non-systematic RS |
| | coder is not used |
| 1 | Non-systematic RS |
| | coder is used |

For instance, NRS=0, indicates that the non-systematic RS coder is not used and so one robust packet will be coded into two symbol segments by the FEC block. If NRS=1, then that indicates that the systematic RS coder is used and therefore a group of four robust packets will be coded into nine symbol segments by the FEC block. Tables 8 and 9 illustrate example ratios of the number of robust packets per frame (i.e., the number of Robust packets vs. the number of standard packets, per frame (mix) and, example corresponding bit-rates for NRS=0 and NRS=1, respectively.

TABLE 8

| # of Robust/# of | | |
|---|---|---|
| standard packets, | Bit Rate | |
| per frame(mix) | Robust | Standard |
| 0/312 (0%) | 0 | 19.28 |
| 2/308 | 123.589 Kbps | 19.033 Mbps |
| 3/306 (2%) | 185.385 Kbps | 18.909 Mbps |
| 4/304 | 247.179 Kbps | 18.785 Mbps |
| 6/300 | 370.769 Kbps | 18.538 Mbps |
| 8/296 (5%) | 484.359 Kbps | 18.291 Mbps |
| 12/288 | 741.538 Kbps | 17.797 Mbps |
| 16/280 (10%) | 988.718 Kbps | 17.302 Mbps |
| 20/272 (13%) | 1.236 Mbps | 16.808 Mbps |
| 26/260 (16%) | 1.606 Mbps | 16.067 Mbps |
| 32/248 (20%) | 1.977 Mbps | 15.325 Mbps |
| 39/234 (25%) | 2.410 Mbps | 14.460 Mbps |
| 52/208 (33%) | 3.213 Mbps | 12.853 Mbps |
| 78/156 (50%) | 4.820 Mbps | 9.640 Mbps |
| 104/104 (66%) | 6.427 Mbps | 6.427 Mbps |
| 156/0 (100%) | 9.640 Mbps | 0 |

Table 8 particularly indicates the bit-rates of the respective robust and the standard bit-streams for different mix values, when NRS=0. It should be noted that the mix percentages indicated in Table 4 are rounded off values.

TABLE 9

| # of Robust/# | | |
|---|---|---|
| of Standard | | |
| packets, per | Bit Rate | |
| frame | Robust | Standard |
| 0/312 | 0 | 19.28 Mbps |
| 4/303 | 247.179 | 18.724 Mbps |
| | Kbps | |
| 8/294 | 484.359 | 18.168 Mbps |
| | Kbps | |
| 12/285 | 741.538 | 17.612 Mbps |
| | Kbps | |
| 16/276 | 988.718 | 17.055 Mbps |
| | Kbps | |
| 20/267 | 1.236 | 16.499 Mbps |
| | Mbps | |
| 24/258 | 1.483 | 15.943 Mbps |
| | Mbps | |
| 28/249 | 1.730 | 15.387 Mbps |
| | Mbps | |
| 32/240 | 1.977 | 14.831 Mbps |
| | Mbps | |
| 40/222 | 2.472 | 13.718 Mbps |
| | Mbps | |
| 52/195 | 3.213 | 12.050 Mbps |
| | Mbps | |
| 64/168 | 3.955 | 10.382 Mbps |
| | Mbps | |
| 72/150 | 4.449 | 9.269 Mbps |
| | Mbps | |
| 76/141 | 4.696 | 8.713 Mbps |
| | Mbps | |
| 96/96 | 5.932 | 5.932 Mbps |
| | Mbps | |
| 120/42 | 7.415 | 2.595 Mbps |
| | Mbps | |

Table 9 particularly indicates the bit-rates of the robust and the standard bit-streams for different mix values when NRS=1.

Referring back to Table 5, the third “NRP” parameter indicates the Number of Robust Packets in a frame. Table 10 may be used to map this 4 bit number to the number of robust packets in a frame. Thus, for example, if NRP=0110 and NRS=0, then the number of robust packets after encoding is equal to 2*12=24. If NRP=1000 and NRS=1, then the number of robust packets after encoding is equal to 9*32/4=72.

TABLE 10

| | Number of robust packets | |
|---|---|---|
| | before encoding | |
| NRP | NRS = 0 | NRS = 1 |
| 0000 | 0 | 0 |
| 0001 | 2 | 4 |
| 0010 | 3 | 8 |
| 0011 | 4 | 12 |
| 0100 | 6 | 16 |
| 0101 | 8 | 20 |
| 0110 | 12 | 24 |
| 0111 | 16 | 28 |
| 1000 | 20 | 32 |
| 1001 | 26 | 40 |
| 1010 | 32 | 52 |
| 1011 | 39 | 64 |
| 1100 | 52 | 72 |
| 1101 | 78 | 76 |
| 1110 | 104 | 96 |
| 1111 | 156 | 120 |

Referring back to Table 5, the fourth “RPP” parameter indicates the Robust Packets' Position in a frame. Robust packets may be either distributed uniformly within a frame or arranged contiguously within a frame starting from an initial position. Note that uniform distribution is not possible for all values of NRP. Table 11 describes the various types of robust packet distributions within a frame. From the Table 11, it is understood that for RPP=0, the maximum distance between two successive robust packets is limited to four (4).

TABLE 11

| RPP | Robust packets' position |
|---|---|
| 00 | Distributed uniformly within a frame |
| | with a granularity of one |
| 01 | Distributed uniformly within a frame |
| | with a granularity of two |
| 10 | Distributed uniformly within a frame |
| | with a granularity of four |
| 11 | Arranged contiguously within a frame |
| | starting from position one |

As described herein, robust symbol mapping techniques are utilized to get performance advantage for the new robust bit-stream. This necessitates a control mechanism to track bytes belonging to the robust bit-stream and the standard bit-stream through the FEC section of the transmitter.

FIG. 11 illustrates a high-level diagram of the control unit 214 that provides the needed bits to control the multiplexing of packets and the encoding scheme. Details regarding the specific elements of the control unit may be found in applicant's herein incorporated commonly-owned, co-pending U.S. patent application Ser. No. ______ [Attorney Docket No. US010278, D#15061] Particularly, as shown in FIG. 11, a first generate ‘normal/robust bit’ block 501 generates control information at packet level based on MODE, NRP, NRS and RPP parameters. The output of this block is equal to ‘1’ if the packet belongs to the new robust stream (RS) and is equal to ‘0’ if the packet belongs to the standard stream (NS). The convolutional bit interleaver block 510 is similar to the convolutional byte interleaver 120 specified in the ATSC HDTV standard, except that the memory element is 1 bit instead of 1 byte. This block is used to track bytes through the convolutional interleaver. The trellis interleaver block 525 implements the 12-symbol trellis interleaver. The bit output of this will be equal to 1, for example, when the trellis encoder output symbol belongs to robust stream, and equal to 0, for example, when the output symbol belongs to the normal stream and the 23-bytes (PID and parity bytes) added to the robust stream. The trellis encoder uses this information during encoding. As the receiver needs MODE, NRS, NRP and RPP information in order for it to properly decode both the bit-streams, the parameters have to be robustly encoded so that they can be decoded even in severe multi-path channels. An encode sync header block (not shown) performs this function and places the encoded code-word in a fixed location (reserved bits) in the Field Sync Segment 138.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A digital signal transmission system for transmitting encoded data packets including normal packets for transmission as a normal bit stream and robust packets comprising information for transmission as a robust bit stream for receipt by a receiver device, said system comprising:
a first encoding device for encoding packets belonging to each said robust and normal bit streams;
a control means for tracking individual bytes belonging to said robust and normal bit streams and indicating an encoding mode;
formatting means for formatting tracked bytes belonging to robust packets of said robust bit stream;
a trellis encoder means for producing a stream of trellis encoded bits corresponding to bits of said normal and robust streams, said trellis encoder employing means for mapping trellis encoded bits of said robust and normal packets into symbols;
a second encoding device responsive to said control means for applying non-systematic Reed-Solomon (RS) encoding to formatted packets belonging to said robust bit stream when a backward compatibility mode is indicated; and,
a transmitter device for transmitting said robust bit stream, separately or in conjunction with said normal bit stream over a fixed bandwidth communication channel to said receiver device.

2. The digital signal transmission system as claimed in claim 1, wherein a first receiver device is employed for receiving and processing packets of said robust bit stream as null packets when said backward compatibility mode is applied, said mode ensuring backward compatibility with said first receiver device.

3. The digital signal transmission system as claimed in claim 1, wherein a second receiver device is employed for receiving and processing packets of said robust bit stream at a lower TOV compared to the normal bit-stream regardless of said backward compatibility mode indication.

4. The digital signal transmission system as claimed in claim 1, wherein said control means further indicates a symbol mapping scheme employed for said trellis encoded bits, said trellis encoder employing means for trellis encoding all bits of said robust and normal packets into symbols according to said symbol mapping scheme.

5. The digital signal transmission system as claimed in claim 4, wherein said formatting means comprises:
means responsive to said byte tracking indication of said control means for interleaving only robust encoded bytes of said robust bit stream; and,
means receiving interleaved robust bytes from the robust interleaver means and generating two or more data blocks corresponding to each robust packet to facilitate said trellis encoding.

6. The digital signal transmission system as claimed in claim 5, wherein said means for generating two or more data blocks further comprises:
means for arranging information bits of each said robust byte into least significant bit (LSB) positions of said two or more data blocks for robust encoding in said trellis encoder unit,
said trellis encoder additionally determining values for bits in said most significant bit (MSB) positions of said bytes based on a symbol mapping scheme indicated.

7. The digital signal transmission system as claimed in claim 6, wherein said formatting means further comprises:
means for inserting a plurality of placeholder bytes at various locations in each said two or more data blocks, said placeholder locations for eventually receiving additional bytes generated as a result of said non-systematic RS encoding of formatted packets when said backward compatibility mode is indicated.

8. The digital signal transmission system as claimed in claim 7, wherein said formatting means further comprises:
a means for inserting three header bytes in each data block for identifying the packet at a receiver device, wherein placeholder bytes include a pre-specified location in each said two or more data blocks for eventually receiving said three header bytes.

9. The digital signal transmission system as claimed in claim 7, wherein said second encoding device for applying non-systematic RS encoding comprises:
trellis de-interleaver means for receiving the bit stream from said trellis encoder means and re-generating robust bytes including bits in said most significant bit (MSB) positions of said robust byte having values according to a symbol mapping scheme indicated; and,
a parity byte generator/inserter means for generating said additional bytes for insertion at said placeholder locations.

10. The digital signal transmission system as claimed in claim 9, wherein said second encoding device further comprises byte de-interleaver means for receiving interleaved bytes generated from the trellis encoded symbols and, de-interleaving said robust bytes including those having said inserted additional bytes.

11. The digital signal transmission system as claimed in claim 10, wherein said first encoding means for encoding packets belonging to each said robust and normal bit streams includes a systematic RS encoding device for performing forward error correction (FEC) encoding of packets belonging to each said robust and normal bit streams,
said parity byte generator/inserter means including a non-systematic RS encoding device for performing (FEC) encoding upon said de-interleaved bytes from said byte de-interleaver means and then RS encoding it to generate parity bytes, wherein said additional bytes includes said generated parity bytes.

12. The digital signal transmission system as claimed in claim 1, further including multiplexor device for multiplexing normal stream packets with the robust packets.

13. The digital signal transmission system as claimed in claim 1, wherein said one or more symbol mapping schemes includes one selected from the group comprising: a pseudo 2-VSB symbol mapping scheme, and an enhanced (E)-VSB symbol mapping scheme.

14. The digital signal transmission system as claimed in claim 5, wherein said means responsive to said byte tracking indication for interleaving only robust encoded bytes of said robust bit stream is a robust interleaver structure of the form M*B=207 where M is the length of the memory element and B is the number of segments.

15. The digital signal transmission system as claimed in claim 14, wherein said robust interleaver structure includes values of M=3 and B=69.

16. A method for transmitting digital signals comprising encoded data packets including normal packets for transmission as a normal bit stream and robust packets comprising information for transmission as a robust bit stream for receipt by a receiver device, said method comprising the steps of:
a) encoding packets belonging to each said robust and normal bit streams;
b) tracking individual bytes belonging to said robust and normal bit streams and indicating an encoding mode;
c) formatting tracked bytes belonging to robust packets of said robust bit stream; and,
d) producing a stream of trellis encoded bits corresponding to bits of said normal and robust streams, said trellis encoder further mapping trellis encoded bits of said robust and normal packets into symbols;
e) applying non-systematic Reed Solomon (RS) encoding to formatted packets belonging to said robust bit stream when a backward compatibility mode is indicated; and,
f) transmitting said robust bit stream, separately or in conjunction with said normal bit stream over a fixed bandwidth communication channel to said receiver device.

17. The method as claimed in claim 16, wherein a first receiver device is employed for receiving and processing packets of said robust bit stream as null packets when said backward compatibility mode is applied, said mode ensuring backward compatibility with said first receiver device.

18. The method as claimed in claim 16, wherein a second receiver device is employed for receiving and processing packets of said robust bit stream at a lower TOV compared to the normal bit-stream regardless of said backward compatibility mode indication.

19. The method as claimed in claim 16, further comprising the steps of:
indicating a symbol mapping scheme to be employed for said trellis encoded bits; and
trellis encoding all bits of said robust and normal packets into symbols according to said symbol mapping scheme indicated.

20. The method as claimed in claim 19, wherein said formatting step comprises:
interleaving only robust encoded bytes of said robust bit stream; and,
receiving interleaved robust bytes and generating two or more data blocks corresponding to each robust packet to facilitate said trellis encoding.

21. The method as claimed in claim 20, wherein said step of generating two or more data blocks further comprises:
arranging information bits of each said robust byte into least significant bit (LSB) positions of said two or more data blocks for robust encoding in said trellis encoder unit; and,
determining values for bits in said most significant bit (MSB) positions of said bytes based on a symbol mapping scheme indicated.

22. The method as claimed in claim 21, wherein said formatting step further comprises the step of: inserting a plurality of placeholder bytes at various locations in each said two or more data blocks, said placeholder locations for eventually receiving additional bytes generated as a result of said non-systematic RS encoding of formatted packets when said backward compatibility mode is indicated.

23. The method as claimed in claim 22, wherein said formatting step further comprises the step of:
pre-specifying locations in each said two or more data blocks for eventually receiving three header bytes; and
inserting three header bytes in each data block for identifying the packet at a receiver device.

24. The method as claimed in claim 22, wherein said step of applying non-systematic RS encoding comprises the steps of:
receiving the bit stream from said trellis encoder means and re-generating robust bytes including bits in said most significant bit (MSB) positions of said robust byte having values according to a symbol mapping scheme indicated; and,
generating said additional bytes for insertion at said placeholder locations.

25. The method as claimed in claim 24, further comprising the steps of:
receiving interleaved bytes generated from the trellis encoded symbols and, de-interleaving said robust bytes including those having said inserted additional bytes.

26. The method as claimed in claim 25, wherein said encoding step a) comprises:
employing a systematic RS encoding device for performing forward error correction (FEC) encoding of packets belonging to each said robust and normal bit streams.

27. The method as claimed in claim 26, wherein said step of generating said additional bytes for insertion at said placeholder locations includes: employing a non-systematic RS encoding device for performing (FEC) encoding upon said de-interleaved bytes, and then RS encoding to generate said parity bytes, wherein said additional bytes includes said generated parity bytes.

28. The method as claimed in claim 16, further including multiplexing normal stream packets with the robust packets for transmission to said receiver device.

29. The method as claimed in claim 16, wherein said one or more symbol mapping schemes includes one selected from the group comprising: a pseudo 2-VSB symbol mapping scheme, and an enhanced (E)-VSB symbol mapping scheme.

30. The method as claimed in claim 20, wherein said step of interleaving only robust encoded bytes of said robust bit stream is performed by a robust interleaver structure of the form M*B=207 where M is the length of the memory element and B is the number of segments.
